(19) United States
(12) Patent Application Publication
(10) Pub. No.: US 2008/0182647 A1
(43) Pub. Date: Jul. 31, 2008

(54) 3D rendering of 2D legacy game assets

(75) Inventors: Thierry BRUNET DE COURSSOU, Henderson, NV (US); Robert Sprathoff, Las Vegas, NV (US); Cameron Anthony Filipour, Las Vegas, NV (US); Alexander Popovich, Henderson, NV (US); Adam Singer, Henderson, NV (US)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: Cyberview Technology, Inc., Palo Alto, CA (US)

(21) Appl. No.: 12/020,476

(22) Filed: Jan. 25, 2008

Related U.S. Application Data
(60) Provisional application No. 60/886,895, filed on Jan. 26, 2007.

(51) Int. Cl. A63F 9/24; A63F 13/02

(52) U.S. Cl. 463/20; 463/32

(57) ABSTRACT

The 3D Rendering of 2D Legacy Game Assets upgrade method of the present invention represents a means of un-retiring once popular video reel slot machine themes by projecting their 2D game symbols onto virtual reels mapped into a full 3D environment. Because this upgrade strategy makes use of original 2D legacy game artwork and does not require graphic artists to make modifications, it is both easy to implement and cost effective. The conversion process may be fully automated, allowing a mass upgrade of thousands of game titles on a relatively short timetable. Games created via the present 3D Rendering of 2D Legacy Game Assets upgrade method will allow players to enjoy the classic feel and realistic reel spinning action of mechanical reel games while not missing out on advanced features of video reel games like multi-line play and touch screen interactivity. In addition to combining never before possible feature groupings and rescuing a wealth of legacy games from obsolescence, these upgraded virtual reel games and their dynamic 3D assets represent a major technological advance in the slot machine industry as well as a means to rapidly increase the library of games available for download to slot machines.

### BACKGROUND OF THE INVENTION

1. Field of the Invention

The present inventions relate generally to the field of regulated pay computer-controlled games, either games of skills or games of chance.

2. Description of the Prior Art and Related Information

Video reel slot machines are significantly different than mechanical reel slot machines in both feel and appearance. While mechanical reel slot machines, also known as “reel spinners,” feature visibly curved, physical reels that clearly move in space and time, video reel games have a more flat appearance since their “reels” are illustrated onscreen and don't physically spin. Instead, video reels attempt to simulate spinning using creative 2D animations. These animations are only moderately effective since they are limited to two dimensions.

These differences in reel appearances and reel movement are not the only key distinctions between reel spinners and video slot machines. Video machines often take full advantage of the rich color palates, captivating animations, touch-screen interactivity, and appealing sounds made possible by their medium. Realizing that players respond well to these advancements, mechanical reel game designers have begun to supply their games with more colorful symbols and creative art as well as top screen video with touch-screen interactivity for secondary non-reel games. Mechanical reel game designers are more limited by their medium, however, so as a market segment, reel spinners remain considerably more sparse, color-limited, and static in appearance than their video counterparts.

Despite the emergence of colorful, dynamic multi-line video slot machines in the early 1990s, traditional mechanical reel machines continue to retain a significant and loyal customer base. While modern video slots support a number of exciting and innovative features that traditional mechanical machines are unable to offer (such as multi-line play, touch-screen interactivity, animated bonus rounds, and cutting edge graphics), many mechanical reel loyalists find that the nostalgia and classic feel that traditional machines afford them outweighs the appeal of the new video features.

The business advantages of mechanical reel games are not limited to the loyalty these games have earned among a key market segment. Mechanical reel games have a much longer shelf life than video reel games, since players are less likely to tire of their more classic themes. Video reel games, by contrast, enjoy a relatively short lifespan and, as a result, both game developers and game operators are forced to retire many expensive, once-profitable games earlier than would be financially optimal.

In an attempt to bridge the gap between the nostalgia of mechanical reel machines and the increased features of video machines, WMS Gaming Inc., of Waukegan, Ill. developed and released its Transmissive Reels platform in 2006. Transmissive Reels games project video content, namely brightly colored paylines, over mechanical reels, an innovation accomplished by overlaying the mechanical reels with a transparent, non-reflective LCD screen which hosts the video content. While this platform does enhance the mechanical reel gaming experience, it still suffers from many of the limitations of traditional mechanical reel games, including static reel art, inflexibility, and more limited color possibilities.

### SUMMARY OF THE INVENTION

According to an embodiment thereof, the present invention is a gaming machine including a display and a plurality of three-dimensional reels displayed on the display, the plurality of reels each including a plurality of symbols and each being configured to spin and wherein, as the plurality of reels spin, a top-most and a bottom-most symbol of each of the plurality of reels is configured to dynamically take on a skewed appearance.

Another embodiment of the present invention is a method, including steps of providing a gaming machine having a display; configuring the gaming machine to display a plurality of three-dimensional reels on the display, each of the plurality of reels including a plurality of symbols; configuring the gaming machine to spin the displayed reels, and configuring the gaming machine such that, as the displayed plurality of reels spin, a top-most and a bottom-most symbol of each of the plurality of reels dynamically skews in appearance.

Yet another embodiment of the present invention is a gaming machine, including a display and a plurality of three-dimensional reels displayed on the display, each of the plurality of reels including a plurality of symbols rendered about an outer curved surface of the three-dimensional reel, only some of symbols being visible to a player at any given time, the gaming machine being configured to display an animation wherein at least the visible ones of the plurality of symbols of each reel dynamically flatten from the curved surface into a flat strip of symbols.

A still further embodiment of the present invention is a method, including steps of providing a gaming machine having a display; configuring the gaming machine to display a plurality of three-dimensional reels on the display, each of the plurality of reels including a plurality of symbols rendered about an outer curved surface of the three-dimensional reel, only some of symbols being visible to a player of the gaming machine at any given time, and displaying an animation in which at least the visible ones of the plurality of symbols of each reel dynamically flatten from the curved surface into a flat strip of symbols.

The displaying step may be carried out with the animation including dynamically rendering each flat strip of symbols back onto the curved surface of its respective three-dimensional reel.

Another embodiment of the present invention is a gaming machine including a display and a plurality of three-dimensional reels displayed on the display, the plurality of reels each including a plurality of symbols and each being configured to spin and wherein at least one of the plurality of three-dimensional reels is displayed having at least one of texture, cracks and chips indicating aging.

Still another embodiment of the present invention is a method, including providing a gaming machine having a display; configuring the gaming machine to display a plurality of three-dimensional reels on the display, each of the plurality of reels including a plurality of symbols; configuring the gaming machine to spin the displayed reels, and configuring the gaming machine such that the at least one of the plurality of three-dimensional reels is displayed having at least one of texture, cracks and chips indicative of aging.

A gaming machine, according to yet another embodiment of the present invention, comprises a display and a plurality of three-dimensional reels displayed on the display, the plurality of reels each including a plurality of symbols and each being configured to spin and wherein the plurality of three-dimensional reels are displayed having a selectable degree of opacity or transparency.

The present invention, according to another embodiment thereof, is a method, including providing a gaming machine having a display; configuring the gaming machine to display a plurality of three-dimensional reels on the display, each of the plurality of reels including a plurality of symbols; configuring the gaming machine to spin the displayed reels, and configuring the gaming machine such that the plurality of three-dimensional reels are displayed having a selectable degree of opacity or transparency.

A gaming machine, according to another embodiment of the present invention includes a display and a plurality of sets of symbols, wherein each of the sets of symbols is disposed on a torus or doughnut shape that is displayed on the display, the torus or doughnut shapes on the display being configured to spin such that only some of the symbols of each set are visible to a player at any given time.

Another embodiment of the present invention is a method, including providing a gaming machine having a display; configuring the gaming machine to display a plurality of torus or doughnut shapes on the display, each of the displayed plurality of torus or doughnut shapes including a plurality of symbols disposed thereon, and configuring the gaming machine to spin the displayed torus or doughnut shapes such that only some of the symbols displayed on each torus or doughnut shape are visible to a player at any given time.

### BRIEF DESCRIPTION OF THE DRAWINGS

FIG. 1A depicts a conventional 2D video reel.

FIG. 1B shows a virtual reel with the 2D legacy symbols projected over it, according to an embodiment of the present invention.

FIG. 2A shows the multiple paylines of a conventional 5-reel game.

FIG. 2B shows the multiple paylines of a virtual 3D projection 5-reel game, according to embodiments of the present invention.

FIG. 3 illustrates how virtual reels according to embodiments of the present invention may be flattened out to more clearly reveal whether a reward generating symbol combination has been achieved during game play.

FIG. 4 depicts two possible embodiments for a virtual reel according to embodiments of the present invention, one featuring transparency and another featuring opacity.

FIG. 5 depicts another embodiment of a virtual reel shape, according to embodiments of the present invention: the torus.

FIG. 6 depicts virtual reels that feature animated symbols, according to embodiments of the present invention.

FIG. 7 demonstrates how upgraded gaming machines may be made more visually appealing via extrusion of 2D symbols and graphic art, according to embodiments of the present invention.

FIG. 8 demonstrates how legacy game symbols may be projected to flipping 3D surfaces as opposed to spinning surfaces, according to embodiments of the present invention.

FIG. 9 demonstrates a 3D perspective view of virtual reels, according to embodiments of the present invention.

### DETAILED DESCRIPTION

In the following detailed description of exemplary embodiments of the invention, reference is made to the accompanying drawings, which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the spirit or scope of the present invention. The following detailed description is, therefore, not to be taken in a limiting sense, and the scope of the present invention is defined only by the appended claims.

The 3D Rendering of 2D Legacy Game Assets upgrade strategy according to embodiments of the present invention represents a new solution in the campaign to combine the advantages of both mechanical reel and video reel gaming machines. According to embodiments of the present invention, this 3D rendering may be accomplished by taking the existing, unmodified 2D symbols from video reel games and leveraging emerging technologies to project those symbols over simulated mechanical reels (also known as virtual reels) in cutting edge 3D video.

The principle business advantages of this upgrade strategy are simplicity, speed of implementation, and cost-effectiveness. Since original 2D symbols, in raster form or vector form, or a combination of both, may be used unaltered, game upgrades may be performed without involving graphic artists. Using a series of automated procedures and 3D implementation techniques such as dynamic lighting, automatic perspective, bump mapping, outline extrusion, and radius smoothing, to name a few, programmers can quickly produce upgraded games that give players the look, feel, and realistic spinning action of a mechanical reel game with all the dazzling colors, light reflections, captivating animations, and flexibility of a video reel machine. Because of its reliance on packaged effects, the upgrade strategy may involve only minor programmer input or it may be fully automated.

Once upgraded, games featuring virtual reels will offer a refreshed and exciting new gaming experience that will appeal to a wider variety of players. These machines will also allow many costly video reel games to enjoy renewed and extended vitality when they are upgraded for play on this platform.

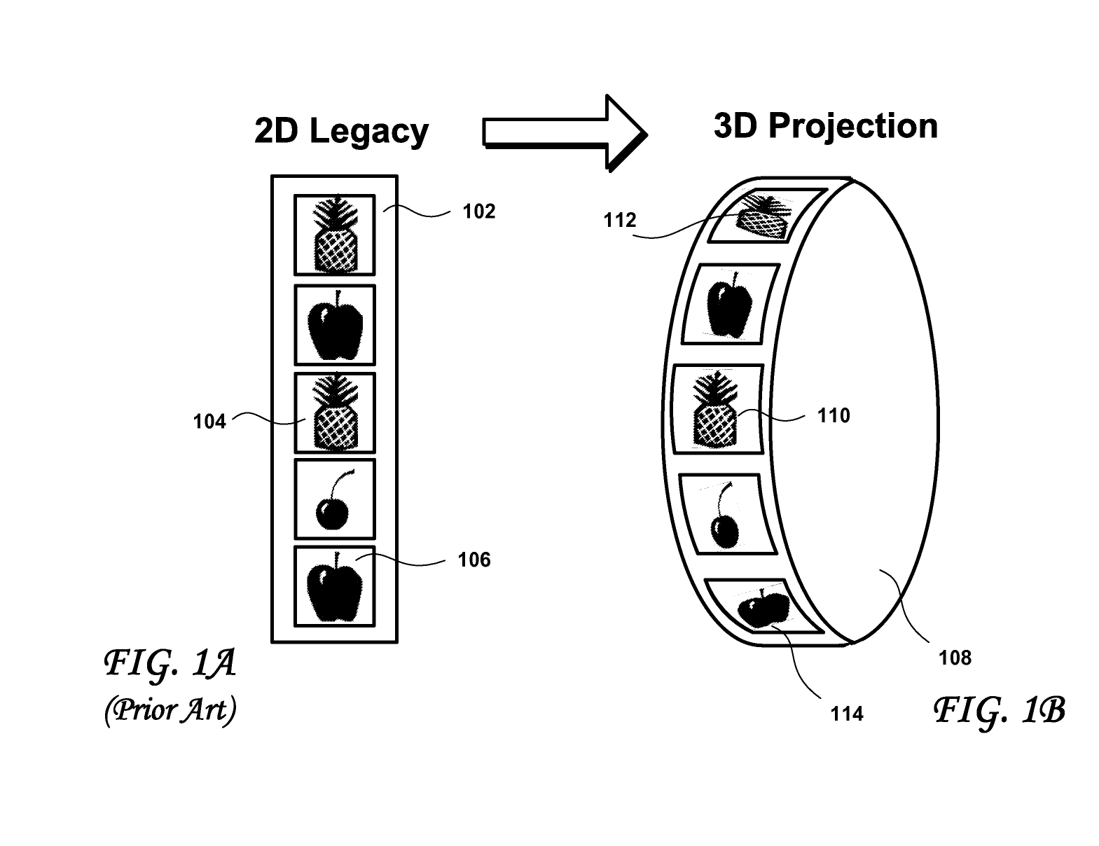

FIG. 1A depicts a conventional 2D video reel and FIG. 1B shows a 3D virtual reel with the 2D legacy symbols projected over it. The reel illustrations in legacy video slot machines of the prior art are limited to only two dimensions, as shown at 102. Like the reels, the game symbols 104 on these machines are flat. When a player initiates a game, the machine uses animation to simulate the spinning of the reels on a vertical plane. Such animation is typically handled in one of two ways: 1) by depicting game symbols in steady downward motion or 2) by having the game symbols becoming unreadable and then readable again, all in an animated whirr. Sometimes a blurring effect is used to enhance the first method. Neither strategy, however, truly approximates realistic spinning, since mechanical reels are curved and since mechanical reel symbols reflect this curvature by becoming less visible at both the top and bottom of a reel. Video reel symbols typically do not appear any different at the top or bottom 106 of a reel than they do in the middle 104, which detracts from their realism. Furthermore, realistic lighting, shading and light reflection of the 2D objects as they move are not rendered during these animations.

Virtual reels according to embodiments of the present invention address these video slot reel presentation limitations by presenting realistic, 3D reel simulations. Whereas the majority of video slot reels are animated flat, virtual reels 108 are curved like their mechanical counterparts. The 2D symbols (in raster form or in vector form, or a combination of both) are directly projected onto the virtual reels' surface and curvature along with the reel such that symbols appearing in the middle of a reel 110 appear larger and more visible than symbols appearing at either the top or bottom of a reel 114.

Virtual reels according to embodiments of the present invention enjoy further advantages over 2D video reels. Since virtual reels are created by a 3D engine and take advantage of a full 3D environment, they allow for a far greater degree of programming flexibility. Effects such as applying a reflection attribute to the projected 2D symbols and configuring dynamic lighting may be used to dramatize onscreen animations. The position of one or a plurality of light sources may be freely configured. The color of each light source may also be freely configured, as may be the angle of each light source to simulate the effect of a theater/scene search/follow light. Each light source may be configured to move in space, in a “fire-fly” style effect. All of these lighting effects allow onscreen graphics assets in motion to cast realistic dramatic moving shadows and reflections. In addition, the angle of view of complete scenes may be changed during game play while the lighting attributes remain active.

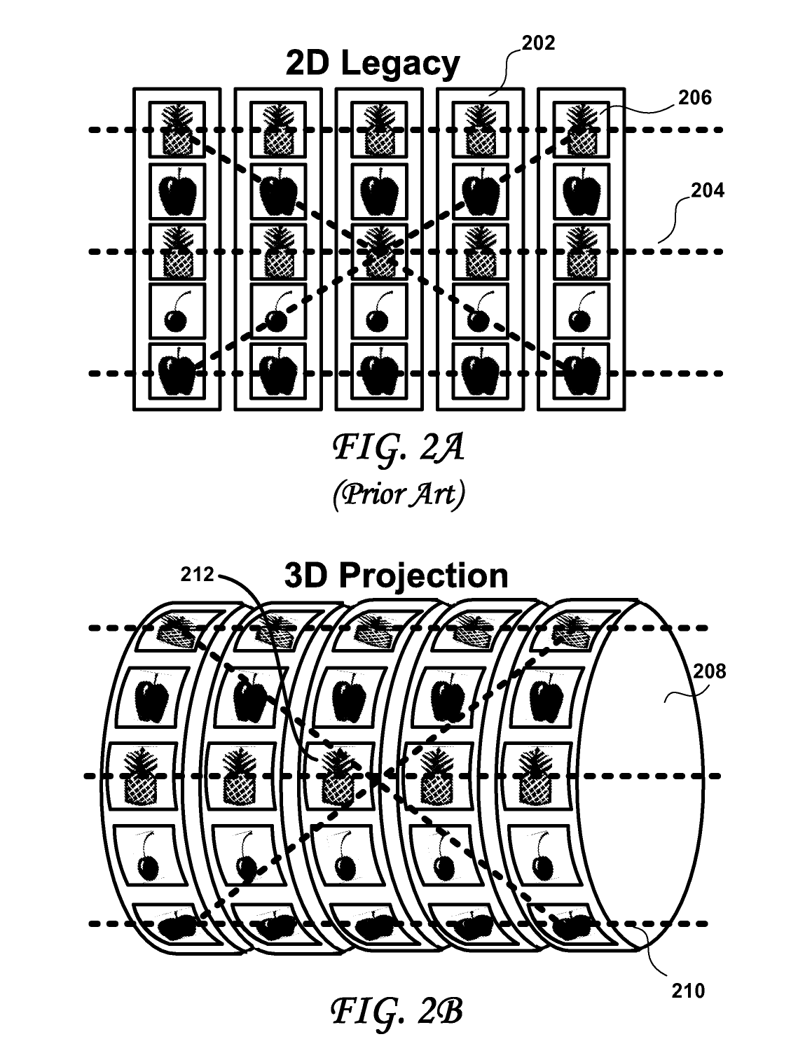

FIG. 2A demonstrates how flat, 2D reels 202 better support multi-line play than the curved reels of FIG. 2B. While the two dimensionality of video reel games makes their spinning animations less realistic, such a configuration better supports multi-line play since it is easier to accurately broadcast paylines 204 across flat surfaces than it is to broadcast them across curved surfaces. No matter where symbols 206 appear on flat reels, they are clearly visible to the player and their relationship to paylines is visually apparent.

The relationship between symbols and paylines on a curved reel 208 is more difficult to express visually. Because paylines 210 are straight and the reels are curved, paylines do not always directly cross the symbols they are meant to cover as apparent at reference numeral 212, making it more difficult for players to associate paylines with the symbols that comprise them.

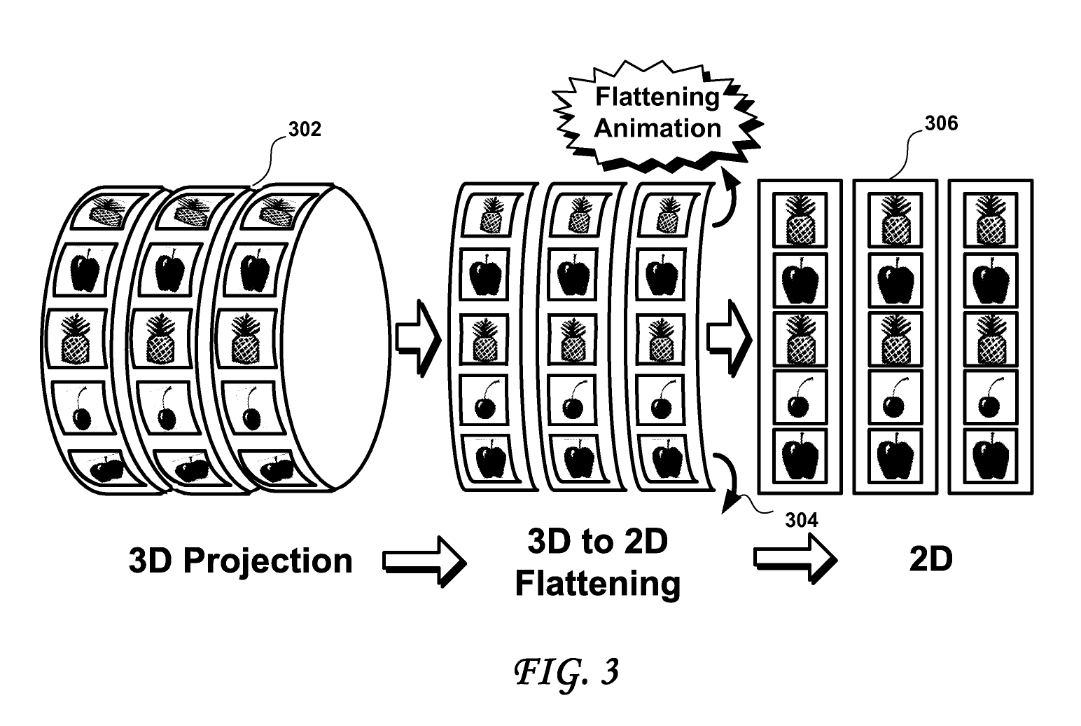

FIG. 3 illustrates how virtual reels might flatten out to more clearly reveal whether a reward generating symbol combination has been achieved during game play, according to embodiments of the present invention. Slot machines using virtual reels are able to maintain the realistic, curved reels of mechanical reel machines while supporting multi-line play by flattening out to display winning paylines when reward-generating symbol combinations are achieved. For example, the virtual reels may appear curved as they spin 302, and then gradually flatten out as they stop spinning 304, until they are fully flat 306. Such a system allows for realistic spin animations as well as full readability of the gaming screen.

In other embodiments of the invention, reels may appear flat both before and after spinning, and curved during spinning. In still other embodiments, reels may remain curved at all times and paylines may curve in 3D to accurately reflect which symbols they cover.

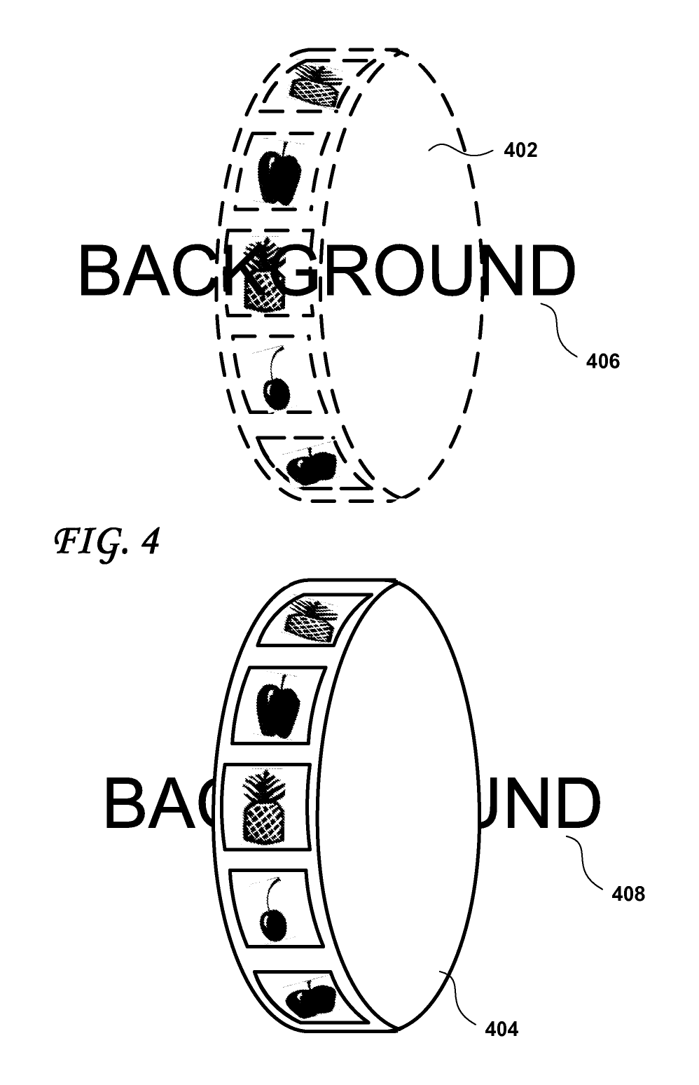

FIG. 4 depicts two possible embodiments for a virtual reel, one featuring transparency and another featuring opacity. Reels may take on different appearance styles based on game conditions and designer preferences. In some cases, it may be necessary for elements of a game background to remain in view at all times, as shown at 406. To meet this requirement, reels featuring transparency 402 may be used to allow simultaneous visibility of both the reel and the game background. In other cases, it may not be important for elements of a game's background to remain in view during game play, as shown at 408. In these cases, reels featuring opacity 404 may be used such that nothing appearing behind the reel is visible to the player. Both effects may be used alternatively, or a transition effect from one mode to the other may be rendered. Alternatively, different levels of transparency (and thus of opacity) may be provided.

The above description underscores the flexibility of the virtual reel platform. Not only may designers select the level of transparency a reel exhibits, they may also overlay art layers or masks such as cracks or chips onto a reel to imply aging and give the game a more classic feel without modifying the original 2D legacy gaming assets. Gaming designers may also simulate glossiness such that symbols and symbol animations are further dramatized by realistic reflection effects that take into account a reel or symbol's surface texture. Or, designers may use techniques like Apple Computer Inc's “aqua effect,” which overlay symbols with pearly, water drop textures that may smooth edges, magnify, and add gloss.

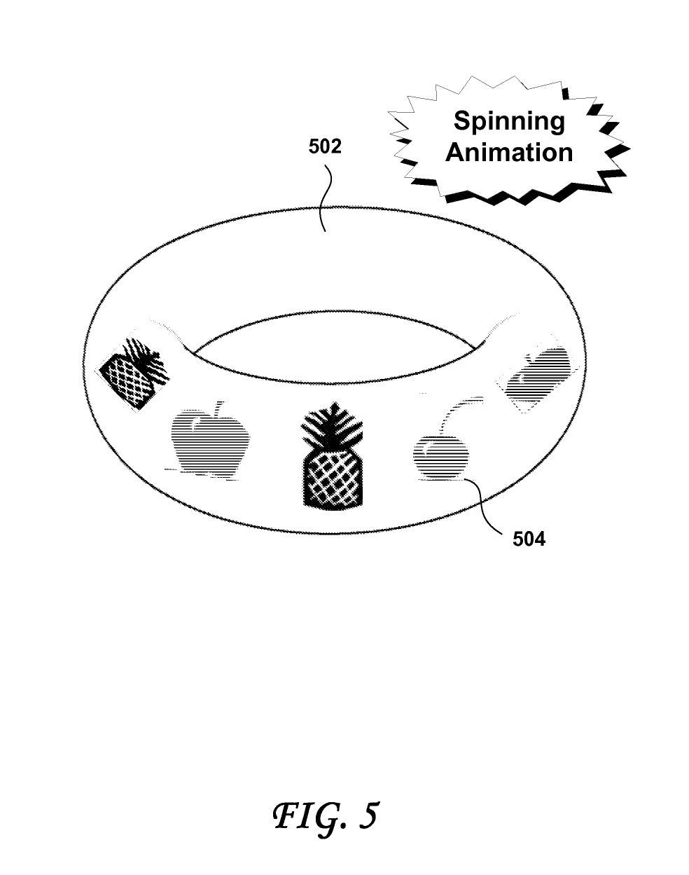

FIG. 5 depicts one possible embodiment of a virtual reel shape: the torus or doughnut shape. The term “virtual reel” has been used to describe the mechanism that holds and moves 2D legacy game symbols in dynamic 3D in the invention described herein, but such symbol transport mechanisms are not limited to traditional reel shapes. The torus 502 is a particularly appealing shape for this process because it may spin like a reel quite naturally and because game symbols 504 may be overlaid onto its surface as a similar, yet visually attractive alternative to the traditional reel. Techniques such as bump mapping may be used to give these shapes a sense of depth and texture and to make them more realistic. Belts and elongated torus shapes may also be used as projection surfaces for the virtual reels. Belts may appear twisted or slackened.

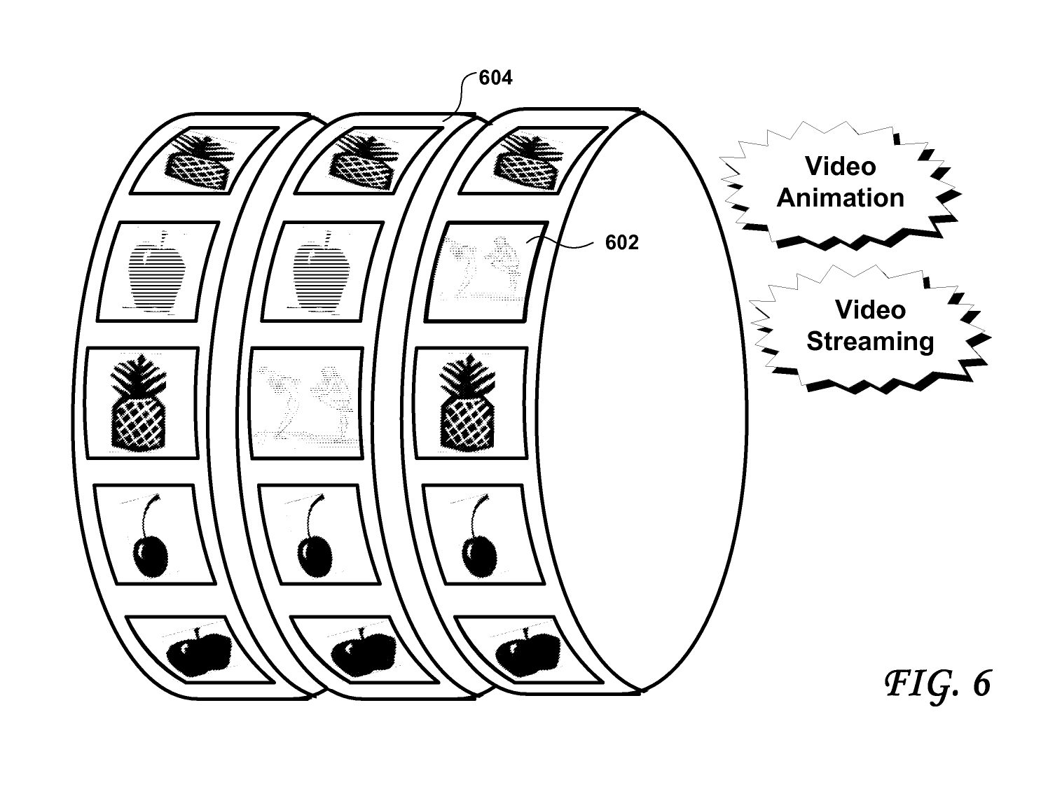

FIG. 6 depicts virtual reels featuring 3D animated symbols, according to further embodiments of the present invention. In an attempt to create more visually appealing games, many video slot designers have incorporated pre-recorded 3D effects into their symbols, effects which are programmed frame by frame, like a film, and which are often triggered during player reward sequences. These effects are not dynamic 3D—they are typically animated GIFs—but do often make use of assets created in a true 3D model that could be mapped in full 3D given the correct platform.

Games that make use of the 3D upgrade described herein may handle these types of symbol in one of two ways. The simplest method is to project these 2D animated symbols 602 over the virtual reels unaltered 604, usually as an animated GIF or any kind of streaming video, as shown in FIG. 6. A method that is often preferable, however, is to deconstruct the animations, map into full 3D any assets that can support the upgrade, and then reconstruct them. Another method is to import the original 3D object, to animate it directly in real-time 3D and to render it—with the static or dynamic lighting effects, view angle and camera path as configured—in the new 3D space of the player video screen while the player is playing.

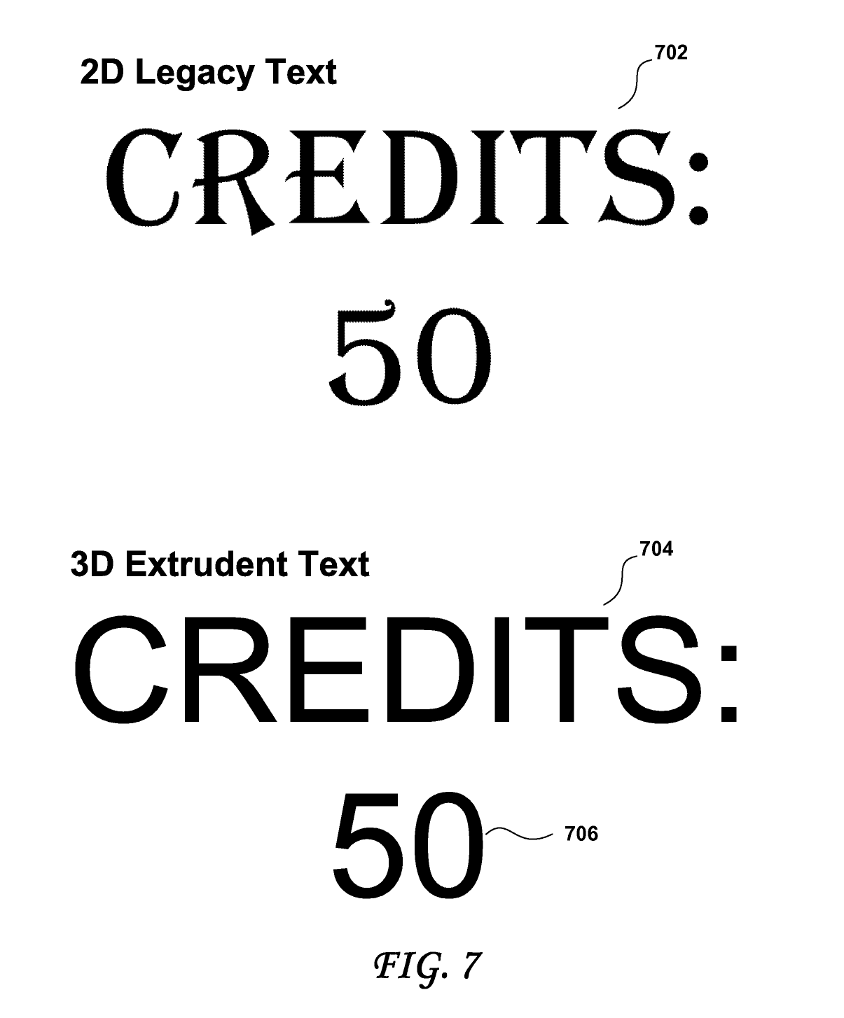

FIG. 7 demonstrates how upgraded gaming machines may be made more visually appealing via extrusion of 2D symbols and graphic art. Any 2D asset may be subjected to extrusion along its edges or its outline. Sharp edges may receive radius smoothing as is often applied in 3D object modeling to give them a softer, more natural looking appearance. Extrusion is a technique commonly employed in 3D mechanical modeling whereby a 2D outline or sketch is extruded to 3D to produce a 3D part. This technique may be advantageously applied to a selected set of the legacy 2D graphic assets or symbols. When symbols are rendered over a plain or uniform background, a cherry over a white background for example, the white background may be automatically punched-out (using the magic wand tool of Photoshop (for example) and then cut, for example) such that only the cherry is rendered over a transparent background, then the outline of the cherry may be extruded to create a 3D part, much like a piece of a puzzle. A radius smoothing or a bevel may be applied much like when designing a 3D mechanical part. Using 3D surface modeling technique such as is made possible with the Rhino3D studio (www.rhino3D.com), a 3D surface pump-up effect may be applied (a pearly or water “aqua” effect for example) giving the cherry a nice 3D look with dynamic lighting while being animated. The process may advantageously be automated.

Games that take advantage of the upgrade described herein, may also use extrusion of the legacy 2D alphanumeric meter assets 702 to build meters with a 3D-like appearance, as shown at 704, 706.

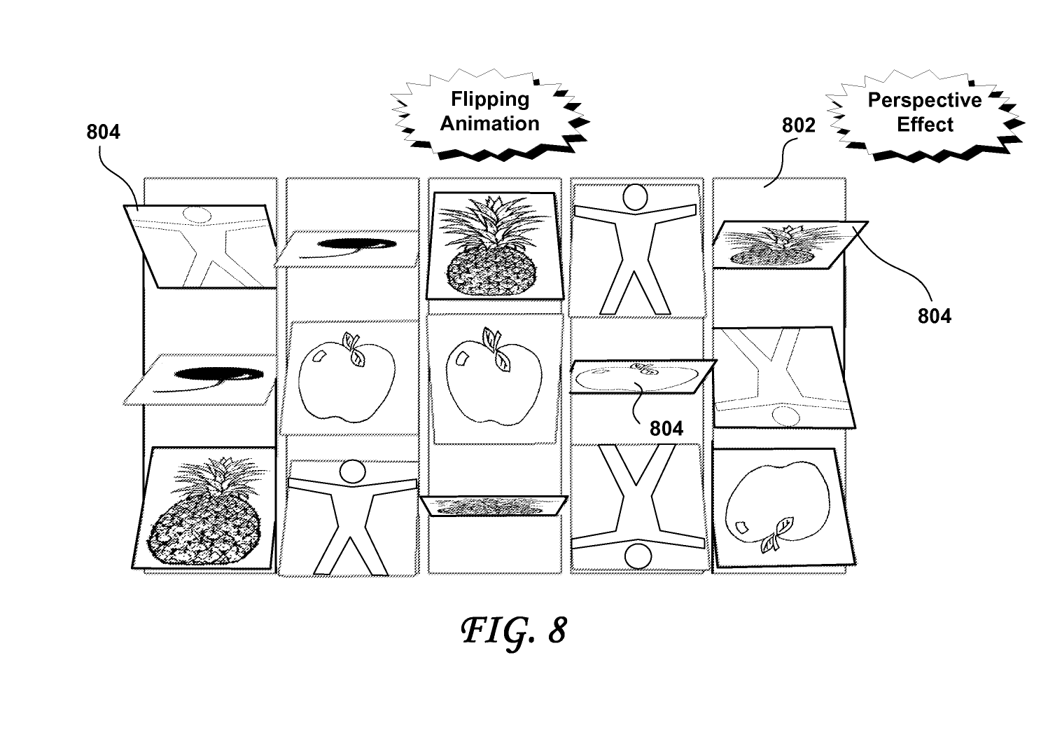

FIG. 8 demonstrates how legacy game symbols may be projected onto flipping 3D surfaces as opposed to spinning surfaces, according to still further embodiments of the present invention. During the game upgrade process, designers may dispense with reels entirely, having 2D legacy symbols flip, shuffle, or twirl in true 3D. For instance, the gaming screen 802 might show a grid of traditional proportions—three symbols tall by 5 symbols wide—but substitute symbol flipping for symbol spinning. In such a model, when the player activates a game, game symbols 804 will flip, revealing a different symbol type with each rotation. In accordance with a perspective angle and 3D perspective law, the symbols are dynamically warped as they move forward or backward, and away from the center. While such a model represents a departure from traditional game animations, it may rely on traditional random number generation systems to determine game outcome.

More generally, 2D legacy symbols may be projected to any kind of 3D surface that may cover an object moving in 3D space, and not limited to cylinders, belts, torus, flipping cards, water drops and projectiles.

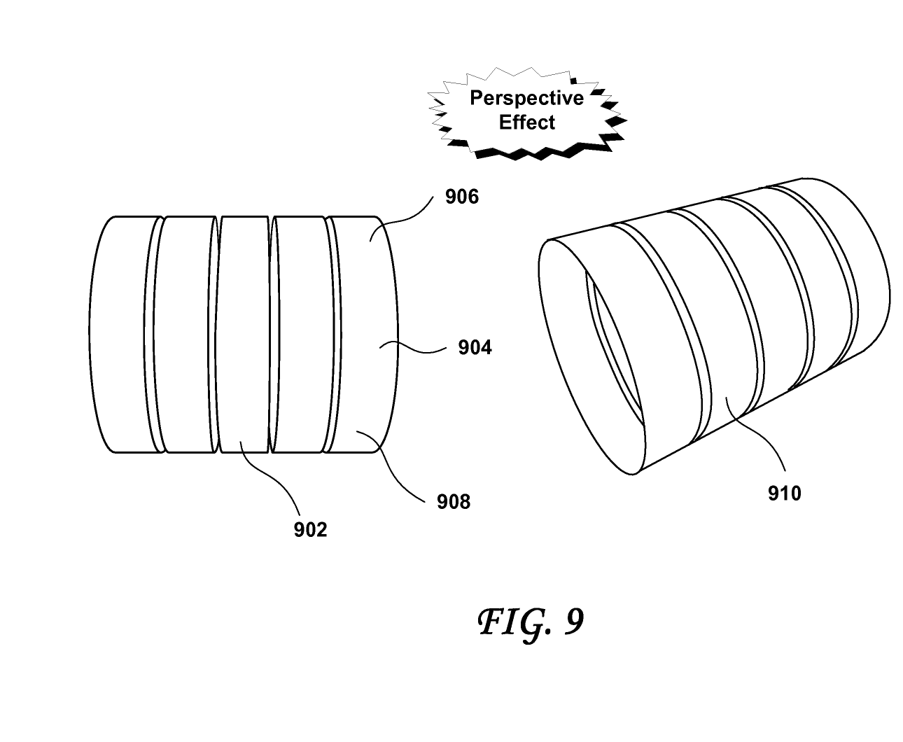

FIG. 9 demonstrates the 3D perspective view of virtual reels, according to another embodiment of the present invention. Unlike the majority of video reels, which are 2D and flat and rather square in appearance, virtual reels 902, when viewed across the player display, present a curved aspect to render perspective. Such curvature is most easily noticed by observing the center of each reel 904 which is clearly larger and more prominently displayed than either the top 906 or bottom 908 of the reel. As the angle of view of the camera angle is being dynamically changed, the curvatures of the 3D virtual reels 910 may be warped together with the 2D symbols projected onto it. The complete scene surrounding the 3D virtual reels (the meters for example) may follow the same dynamic perspective rendering.

While the foregoing detailed description has described several embodiments of this invention, it is to be understood that the above description is illustrative only and not limiting of the disclosed invention. For example, while a torus shaped virtual reel was described, reels might be shaped like orbs, stars, belts, or mechanical gears. Indeed, a number of modifications will no doubt occur to persons of skill in this art. All such modifications, however, should be deemed to fall within the scope of the present invention.

What is claimed is:

1. A gaming machine comprising a display and a plurality of three-dimensional reels displayed on the display, the plurality of reels each including a plurality of symbols and each being configured to spin and wherein, as the plurality of reels spin, a top-most and a bottom-most symbol of each of the plurality of reels is configured to dynamically take on a skewed appearance.

2. A method, comprising:
providing a gaming machine having a display;
configuring the gaming machine to display a plurality of three-dimensional reels on the display, each of the plurality of reels including a plurality of symbols;
configuring the gaming machine to spin the displayed reels, and
configuring the gaming machine such that, as the displayed plurality of reels spin, a top-most and a bottom-most symbol of each of the plurality of reels dynamically skews in appearance.

3. A gaming machine, comprising a display and a plurality of three-dimensional reels displayed on the display, each of the plurality of reels including a plurality of symbols rendered about an outer curved surface of the three-dimensional reel, only some of symbols being visible to a player at any given time, the gaming machine being configured to display an animation wherein at least the visible ones of the plurality of symbols of each reel dynamically flatten from the curved surface into a flat strip of symbols.

4. A method, comprising:
providing a gaming machine having a display;
configuring the gaming machine to display a plurality of three-dimensional reels on the display, each of the plurality of reels including a plurality of symbols rendered about an outer curved surface of the three-dimensional reel, only some of symbols being visible to a player of the gaming machine at any given time, and
displaying an animation in which at least the visible ones of the plurality of symbols of each reel dynamically flatten from the curved surface into a flat strip of symbols.

5. The method of claim 4, wherein the displaying step is carried out with the animation including dynamically rendering each flat strip of symbols back onto the curved surface of its respective three-dimensional reel.

6. A gaming machine comprising a display and a plurality of three-dimensional reels displayed on the display, the plurality of reels each including a plurality of symbols and each being configured to spin and wherein at least one of the plurality of three-dimensional reels is displayed having at least one of texture, cracks and chips indicating aging.

7. A method, comprising:
providing a gaming machine having a display;
configuring the gaming machine to display a plurality of three-dimensional reels on the display, each of the plurality of reels including a plurality of symbols;
configuring the gaming machine to spin the displayed reels, and
configuring the gaming machine such that the at least one of the plurality of three-dimensional reels is displayed having at least one of texture, cracks and chips indicative of aging.

8. A gaming machine comprising a display and a plurality of three-dimensional reels displayed on the display, the plurality of reels each including a plurality of symbols and each being configured to spin and wherein the plurality of three-dimensional reels are displayed having a selectable degree of opacity or transparency.

9. A method, comprising:
providing a gaming machine having a display;
configuring the gaming machine to display a plurality of three-dimensional reels on the display, each of the plurality of reels including a plurality of symbols;
configuring the gaming machine to spin the displayed reels, and
configuring the gaming machine such that the plurality of three-dimensional reels are displayed having a selectable degree of opacity or transparency.

10. A gaming machine comprising a display and a plurality of sets of symbols, wherein each of the sets of symbols is disposed on a torus or doughnut shape that is displayed on the display, the torus or doughnut shapes on the display being configured to spin such that only some of the symbols of each set are visible to a player at any given time.

11. A method, comprising:
providing a gaming machine having a display;
configuring the gaming machine to display a plurality of torus or doughnut shapes on the display, each of the displayed plurality of torus or doughnut shapes including a plurality of symbols disposed thereon, and
configuring the gaming machine to spin the displayed torus or doughnut shapes such that only some of the symbols displayed on each torus or doughnut shape are visible to a player at any given time.
